(19) United States
(12) Patent Application Publication
(10) Pub. No.: US 2026/0183955 A1
(43) Pub. Date: Jul. 2, 2026

(54) INFORMATION PROCESSING APPARATUS

(71) Applicant: FANUC CORPORATION, Yamanashi (JP)

(72) Inventor: Wanfeng FU, Yamanashi (JP)

(21) Appl. No.: 18/867,805

(22) PCT Filed: Jun. 2, 2022
(86) PCT No.: PCT/JP2022/022491

§ 371 Date: Nov. 21, 2024

(51) Int. Cl. B25J 9/16; G06T 11/26; G06T 17/00

(52) U.S. Cl. CPC B25J 9/1674; G06T 11/26; G06T 17/00; G06T 2200/24

(57) ABSTRACT

An information processing apparatus according to one aspect of the present disclosure is connected to an industrial machine equipped with a sensor or a control device that controls the industrial machine. The information processing apparatus is provided with a storage unit that stores first table data in which a plurality of abnormality causes are associated with a plurality of abnormal situations related to operation of the industrial machine, an abnormality monitoring unit that monitors the occurrence of an abnormal situation in the industrial machine, based on data output from the sensor, a cause identification unit that identifies a cause of the abnormal situation with reference to the first table data, and a display control unit that causes a display unit to display details of the abnormal situation and the identified cause of the abnormal situation.

### RELATED APPLICATIONS

The present application is a National Phase of International Application No. PCT/JP2022/022491 filed Jun. 2, 2022.

### TECHNICAL FIELD

The present invention relates to an information processing apparatus having a function of monitoring an industrial machine.

### BACKGROUND ART

Today, robots are indispensable in factories or the like. Robots are equipped with various sensors such as vision and force sensors. By utilizing the output data of the various sensors provided in the robot, the operation timing of the robot can be identified, and the current position of the robot can be grasped. In addition, by utilizing the output data of the various sensors provided in the robot, it is possible to monitor the occurrence of a situation in which the robot is unable to perform a correct operation according to an operation program due to an unintended large load on the robot in operation, vibration of the robot, or sudden stop of the robot, etc., that is, an abnormal situation. For example, an industrial robot having a monitoring function such as abnormality detection is known (for example, Patent Literature 1). When an abnormal situation occurs in a robot, the operator must investigate the cause of the occurrence of the abnormal situation, consider a countermeasure plan, and avoid the same abnormal situation from occurring again.

Conventionally, in order to identify the cause of an abnormal situation, the operator has confirmed the execution history record that is recorded for each operation and output data of various sensors while switching between various screens related to the operation control of the robot provided by the robot. Further, the operator has created a countermeasure plan to solve the identified cause with reference to a manual or the like, adjusted setting information such as operation parameters of the robot, actually operated the robot with the adjusted setting information, and confirmed whether the same abnormal situation would occur again.

### CITATION LIST

### Patent Literature

Patent Literature 1: Japanese Unexamined Patent Application Publication No. 2015-229224

### SUMMARY

### Problem to be Solved

However, when an abnormal situation occurs, it is inefficient to confirm the output data of the sensors and the execution history data while switching between various screens provided by the robot, which may delay the identification of the cause of the abnormal situation or lead to incorrect diagnosis. In addition, in order to create a countermeasure plan to solve the cause of the abnormal situation, it is necessary to first identify the cause of the abnormal situation and then consult manuals, academic materials, etc., which takes a lot of time to solve the cause of the abnormal situation. Therefore, it is desired to develop a technology that can efficiently solve the cause of an abnormal situation when the abnormal situation occurs in a robot.

### Solution to Problem

An information processing apparatus according to one aspect of the present disclosure is connected to an industrial machine equipped with a sensor or a control device for controlling the industrial machine. The information processing apparatus is provided with a storage unit that stores first table data in which a plurality of abnormality causes are associated with a plurality of abnormal situations related to operation of the industrial machine, an abnormality monitoring unit that monitors the occurrence of an abnormal situation in the industrial machine, based on data output from the sensor, a cause identification unit that identifies a cause of the abnormal situation with reference to the first table data, and a display control unit that causes a display unit to display details of the abnormal situation and the identified cause of the abnormal situation.

### BRIEF DESCRIPTION OF THE DRAWINGS

FIG. 1 shows a robot system including an information processing apparatus according to the present embodiment.

FIG. 2 is a block configuration diagram of the information processing apparatus shown in FIG. 1.

FIG. 3 shows an example of a cause identification table stored in a storage unit shown in FIG. 2.

FIG. 4 shows an example of a countermeasure plan identification table stored in the storage unit shown in FIG. 2.

FIG. 5 shows an example of an execution history screen displayed on a display unit shown in FIG. 2.

FIG. 6 shows an example of a cause confirmation screen that pops up on the execution history screen shown in FIG. 5.

FIG. 7 shows an example of a countermeasure plan confirmation screen that pops up on the execution history screen shown in FIG. 6.

FIG. 8 shows an example of an enlarged screen that pops up as a result of a user operation on the execution history screen shown in FIG. 6.

FIG. 9 shows another example of the cause confirmation screen that pops up on the execution history screen shown in FIG. 6.

FIG. 10 is a flowchart showing an example of the procedure of monitoring processing by the information processing apparatus shown in FIG. 1.

### DETAILED DESCRIPTION

Hereinafter, an information processing apparatus according to the present embodiment will be described with reference to the drawings. In the following description, constituent elements having substantially the same function and configuration are denoted by the same reference numeral, and repetitive descriptions will be given only where necessary.

An information processing apparatus according to the present embodiment is a computer apparatus having a function of monitoring an industrial machine that operates according to an operation program, a function of, when an abnormal situation related to the operation occurs in the industrial machine, identifying an abnormality cause of the abnormal situation and notifying the user, a function of identifying a countermeasure plan to solve the abnormality cause of the abnormal situation that has occurred in the industrial machine and notifying the user, and a function of providing a screen that allows the user to easily confirm the operation status of the industrial machine. In the present embodiment, a robot apparatus is described as an example of the industrial machine. However, the industrial machine may be a machine tool, a welding apparatus, or the like, and is not limited to a robot apparatus. Typically, the information processing apparatus according to the present embodiment is configured as follows.

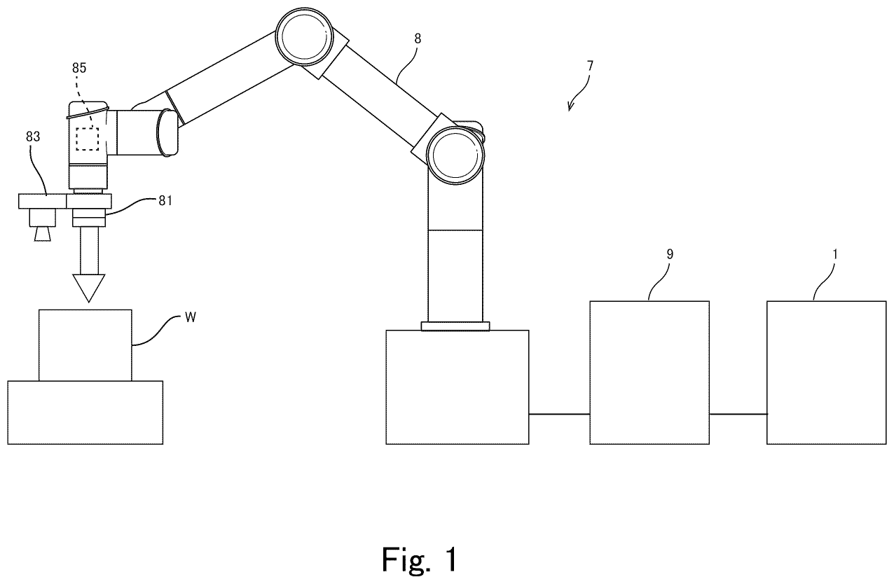

As shown in FIG. 1, an information processing apparatus 1 according to the present embodiment is connected to a robot apparatus 7. The robot apparatus 7 includes a robot arm mechanism 8 and a control device 9 that controls the robot arm mechanism 8. In the present embodiment, the information processing apparatus 1 is connected to the control device 9. The robot arm mechanism 8 includes various sensors such as a force sensor 81 for detecting a load applied to an end effector, a vision camera 83 for capturing an image of a workpiece W or the like, and an encoder 85 for detecting the rotational position of a motor. The types of sensors are not limited to these. Output data of various sensors provided in the robot arm mechanism 8 is input to the information processing apparatus 1 according to the present embodiment via the control device 9.

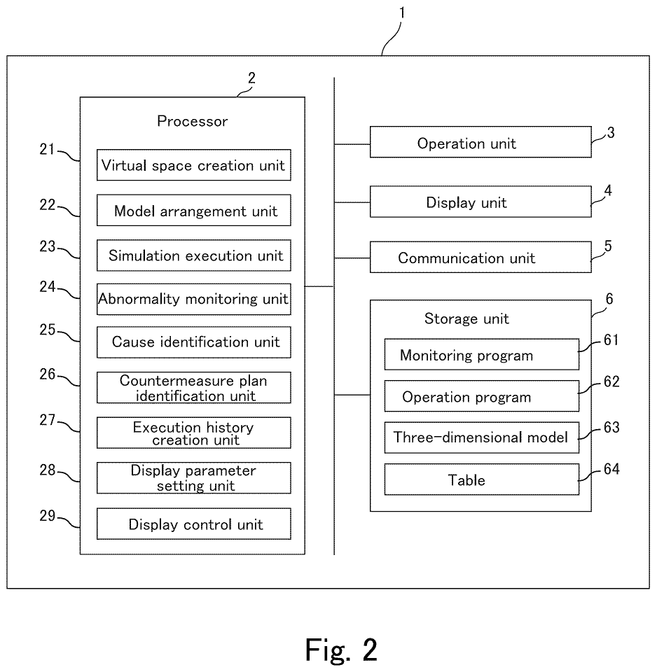

As shown in FIG. 2, the information processing apparatus 11 according to the present embodiment is configured by connecting hardware such as an operation unit 3, a display unit 4, a communication unit 5, and a storage unit 6 to a processor 2 (such as a CPU). The information processing apparatus 11 is provided by a personal computer, a tablet, a smartphone or the like.

The operation unit 3 includes an input device such as a keyboard, a mouse, a jog, or a touch panel. The user can input various types of information into the information processing apparatus 1 through the operation unit 3. The various types of information include user operations on the execution history screen. The user operations on the execution history screen include a parameter selection operation, an execution history record selection operation, selection operations of various buttons, and the like. The display unit 4 includes a display device such as an LCD. The display unit 4 displays an execution history screen, a pop-up screen, and the like in accordance with control of the display control unit 29. The communication unit 5 controls transmission and reception of data to and from the robot apparatus 7. Through the processing of the communication unit 5, the information processing apparatus 1 receives, from the robot apparatus 7, operation information on the robot apparatus 7 being operated according to the operation program 62. The operation information includes information on the operation date and time, information on the operation time, sensor data acquired during the operation, information identifying the used operation program, event information indicating the operation content, and the like.

The storage unit 6 includes a storage device such as an HDD or an SSD. In the storage unit 6, a monitoring program 61 for monitoring the robot apparatus 7, an operation program 62 for the robot apparatus 7, data of three-dimensional models 63, and data of tables 64 are stored in advance. The data of three-dimensional models 63 include data of the three-dimensional model of the robot apparatus 7 and data of the three-dimensional model of the workpiece. Typically, the data of three-dimensional models 63 are provided by CAD data.

The data of tables 64 include data of a first table (hereinafter referred to as a “cause identification table”) used for identifying the abnormality cause of the abnormal situation and data of a second table (hereinafter referred to as a “countermeasure plan identification table”) used for identifying the countermeasure plan for the abnormality cause. Of course, the cause identification table and the countermeasure plan identification table may be provided as a single integrated table.

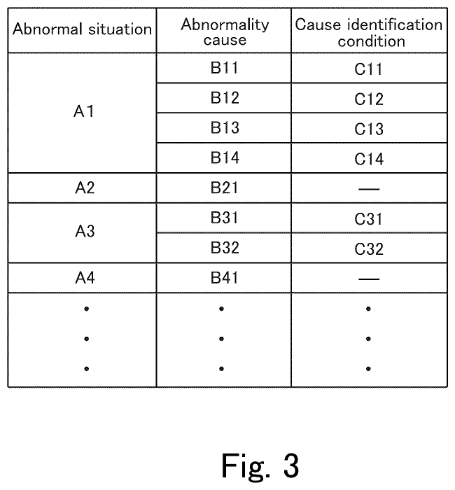

As shown in FIG. 3, the cause identification table associates a plurality of abnormality causes with abnormal situations related to the operation of the robot. For example, one abnormal situation is associated with one abnormality cause, such as abnormality cause “B21” being associated with abnormal situation “A2”. A plurality of abnormality causes may be considered for one abnormal situation. Therefore, a plurality of abnormality causes may be associated with one abnormal situation, such as abnormality causes “B11”, “B12”, “B13”, and “B14” being associated with abnormal situation “A1”. When a plurality of abnormality causes are considered for an abnormal situation, it is desirable that at least one abnormality cause can be identified from the plurality of abnormality causes. Therefore, one cause identification condition may be associated with one abnormality cause, such as four cause identification conditions “C11”, “C12”, “C13”, and “C14” being associated with four abnormality causes “B11”, “B12”, “B13”, and “B14”, respectively.

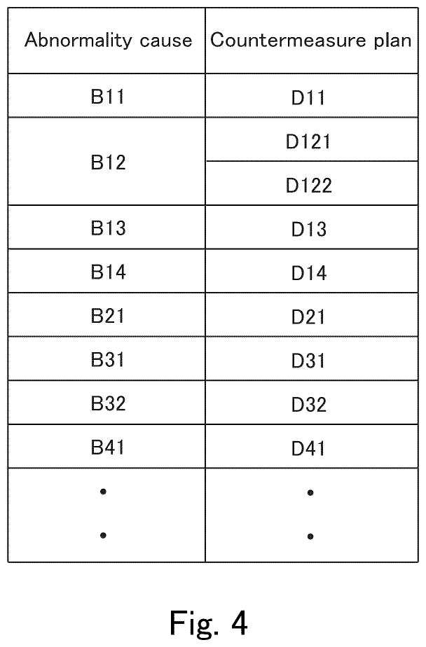

As shown in FIG. 4, the countermeasure plan identification table associates a plurality of countermeasure plans with a plurality of abnormality causes. For example, one countermeasure plan is associated with one abnormality cause, such as countermeasure plan “D11” being associated with abnormality cause “B11”. Of course, there may be a plurality of countermeasure plans for one abnormality cause. Therefore, a plurality of countermeasure plans may be associated with one abnormality cause, such as countermeasure plans “D121” and “D122” being associated with abnormality cause “B12”.

As shown in FIG. 2, when the monitoring program 61 stored in the storage unit 6 is executed by the processor, the information processing apparatus 1 functions as a virtual space creation unit 21, a model arrangement unit 22, a simulation execution unit 23, an abnormality monitoring unit 24, a cause identification unit 25, a countermeasure plan identification unit 26, an execution history creation unit 27, a display parameter setting unit 28, and a display control unit 29.

The virtual space creation unit 21 creates a virtual space on software that three-dimensionally represents an operation space in which the robot apparatus operates. The virtual space created by the virtual space creation unit 21 is displayed in a simulation display area of the execution history screen created by the display control unit 29.

The model arrangement unit 22 arranges a three-dimensional model of the robot apparatus 7 (hereinafter referred to as a robot model) and a three-dimensional model of the workpiece (hereinafter referred to as a workpiece model) in the virtual space created by the virtual space creation unit 21 and displayed on the execution history screen. The robot model and the workpiece model are arranged in the virtual space so as to correspond to the positional relationship between the robot and the workpiece in the actual operation space.

The simulation execution unit 23 executes a simulation operation for operating, in simulation, the robot model in the virtual space created by the virtual space creation unit 21 and displayed on the execution history screen in accordance with the operation program 62 or in accordance with a user instruction through the operation unit 3. For example, the following display can be realized by the processing of the simulation execution unit 23. For example, a robot model displayed in the simulation display area of the execution history screen can be displayed as a moving image in synchronization with the actual operation of the robot apparatus 7. In addition, a robot model that reproduces the operation of the robot apparatus 7 at the time of executing a task corresponding to an execution history record selected by a user operation on the execution history screen can be displayed as a moving image. Further, the output of the sensors at the time of executing a task corresponding to an execution history record selected by a user operation on the execution history screen can be reproduced and displayed.

The abnormality monitoring unit 24 monitors the occurrence of an abnormal situation of the robot apparatus 7. Typically, the abnormality monitoring unit 24 identifies that an abnormal situation has occurred in the robot apparatus 7 based on output data of various sensors provided in the robot apparatus 7. It is noted that the abnormality monitoring unit 24 may be configured to monitor the occurrence of an abnormal situation of the robot apparatus 7 based on the setting information of the sensors, the setting information of the robot apparatus 7, and the like.

The cause identification unit 25 refers to the cause identification table to identify the abnormality cause of the abnormal situation that has occurred. When there are a plurality of abnormality causes of an abnormal situation, the cause identification unit 25 identifies at least one abnormality cause from among the plurality of abnormality causes, based on the outputs of various sensors provided in the robot apparatus 7. For example, in the cause identification table, a plurality of abnormality causes “contact with an obstacle”, “motor failure”, and “incorrect setting information” are associated with an abnormal situation “robot apparatus stop” of the robot apparatus 7. For example, based on the output data of the force sensor and the vision camera provided in the robot apparatus 7, it is possible to identify whether or not the abnormality cause of the robot apparatus 7 having stopped is “contact with an obstacle”. Similarly, the cause identification unit 25 can identify whether the abnormality cause of the robot apparatus 7 having stopped is “motor failure” based on the output data of the encoder that detects the rotation of the motor provided in the robot apparatus 7.

When the abnormality cause is neither “contact with an obstacle” nor “motor failure”, the cause identification unit 25 can identify the “incorrect setting information” as the abnormality cause of the robot apparatus 7 having stopped.

The countermeasure plan identification unit 26 refers to the countermeasure plan identification table to identify a countermeasure plan for solving the identified abnormality cause. For example, in the countermeasure plan identification table, a countermeasure plan “removal of an obstacle” is associated with the abnormality cause “contact with an obstacle” of the robot apparatus 7. Further, countermeasure plans “confirmation of setting information of motor” and “replacement of motor” are associated with the abnormality cause “motor failure” of the robot apparatus 7. When the abnormality cause identified by the cause identification unit 25 is “contact with an obstacle”, the countermeasure plan identification unit 26 refers to the countermeasure plan identification table and identifies the countermeasure plan “removal of an obstacle”. Similarly, when the abnormality cause identified by the cause identification unit 25 is “motor failure”, the countermeasure plan identification unit 26 refers to the countermeasure plan identification table and identifies the countermeasure plans “confirmation of motor setting information” and “motor replacement”.

The execution history creation unit 27 creates an execution history record including an operation date and time, an operation time, an event, a status, an operation program, and the like. For example, the execution history record is created each time a predetermined task is executed. The operation date and time, operation time, event, and the like are identified based on operation information received from the robot apparatus 7. The status includes “normal” and “abnormal”. Tasks for which no abnormal situation has been identified by the abnormality monitoring unit 24 are assigned the status “normal”, and tasks for which the abnormal situation is identified are assigned the status of “abnormal”. Thereby, execution history records in which an abnormal situation occurred are distinguished from the other execution history records. Of course, execution history records in which an abnormal situation occurred may be automatically displayed in a detailed information display area 140 so that they can be distinguished from the other execution history records. In addition, the display mode of the execution history records in which an abnormal situation occurred and the display mode of the other execution history records may be changed by color, design, pattern, or the like. The execution history record corresponding to a task in which an abnormal situation occurred includes an abnormality cause identified by the cause identification unit 25 and a countermeasure plan identified by the countermeasure plan identification unit 26.

The display parameter setting unit 28 sets parameters to be displayed on the execution history screen in accordance with a user instruction through the operation unit 3. The parameters herein include raw data of each sensor provided in the robot apparatus 7 and data obtained by executing predetermined processing on the raw data of each sensor.

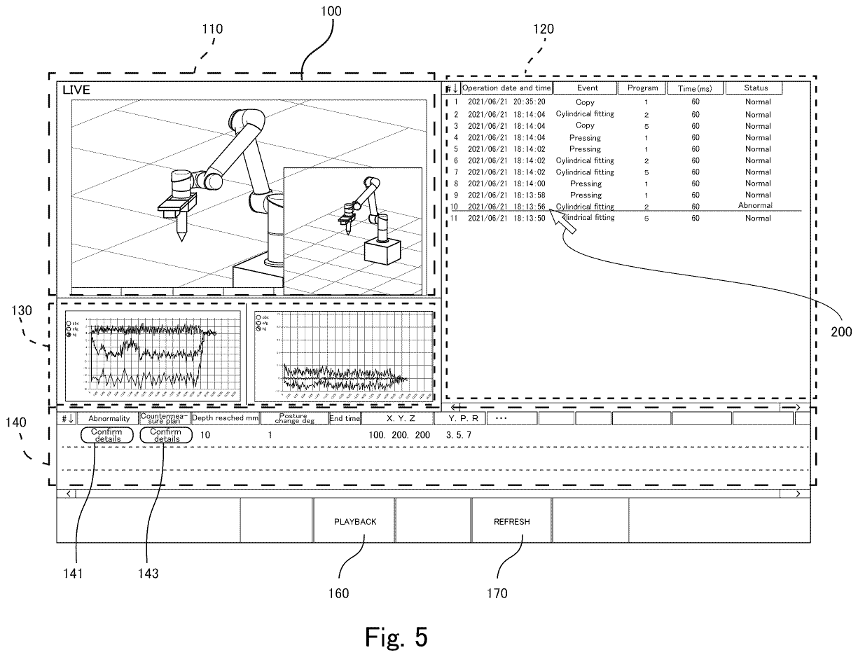

The display control unit 29 creates an execution history screen relating to the result of execution of the operation program 62 by the robot apparatus 7 in accordance with a predetermined format and causes the display unit 4 to display the execution history screen. The execution history screen created by the display control unit 29 will be described below with reference to FIG. 5.

FIG. 5 shows an example of the execution history screen created by the display control unit 29. As shown in FIG. 5, the execution history screen 100 includes a simulation display area 110, an execution history display area 120, a parameter display area 130, a detailed information display area 140, a playback button 160, and a refresh button 170.

A virtual space in which a robot model and a workpiece model are arranged is displayed in the simulation display area 110. For example, the robot model displayed in the virtual space operates in synchronization with the operation of the actual robot apparatus 7. When the playback button 160 is clicked in a state in which an execution history record is selected by the user, the task corresponding to the execution history record is reproduced by simulation, and the robot model displayed in the simulation display area 110 executes the operation corresponding to the execution history record. At this time, the outputs of the sensors are also reproduced, and the sensor outputs reproduced by simulation are displayed in the parameter display area 130. For example, the user can select an execution history record in which an abnormal situation occurred and click the playback button 160 to confirm, through simulation, the operation of the robot apparatus 7 and the outputs of the sensors when the abnormal situation occurred.

The execution history display area 120 displays a list of execution history records created by the execution history creation unit 27. Among the execution history records in the list, the execution history records in which an abnormal situation occurred are desirably distinguished from other execution history records. While the robot apparatus 7 is in operation, the execution history screen 100 is periodically updated, and the execution history records displayed in the execution history display area 120 are added successively. The execution history screen 100 is updated also when the playback button 160 is clicked by the user.

In the parameter display area 130, parameters selected by the user are displayed in a graph format. The parameters include time-series data of sensors and data obtained by performing predetermined calculation processing on the time-series data of sensors. The display format may be a graph format or a table format.

The detailed information display area 140 displays detailed information of the execution history record. The detailed information display area 140 may automatically display a execution history record corresponding to a task in which an abnormal situation occurred, or display an execution history record selected by the user from the execution history record list displayed in the execution history display area 120. If the execution history record displayed in the detailed information display area 140 is that of a task in which an abnormal situation occurred, a cause confirmation button 141 for confirming the details of the abnormal situation and the abnormality cause, and a countermeasure plan confirmation button 143 for confirming a countermeasure plan for solving the abnormality cause are displayed.

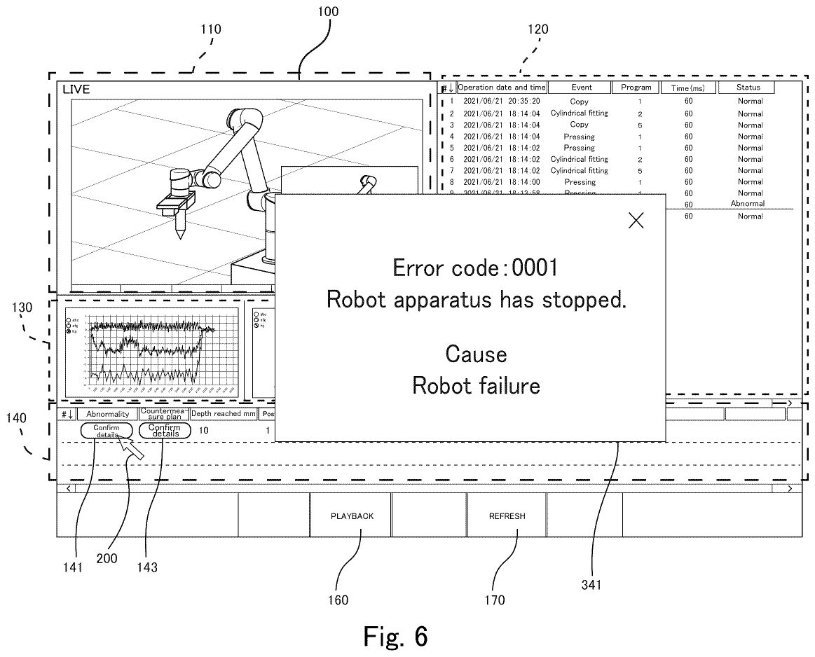

As shown in FIG. 6, when the user clicks the cause confirmation button 141 by operating the cursor 200, a cause confirmation screen 341 including the text relating to the details of the abnormal situation and the abnormality cause pops up on the execution history screen 100. Note that the cause confirmation screen 341 may be displayed in an enlarged manner in the execution history screen 100. In addition, the cause confirmation screen 341 is automatically popped up on the execution history screen 100 when an abnormal situation occurs in a predetermined task in the monitoring processing to be described later. For example, as shown in FIG. 6, the cause confirmation screen 341 displays an error code “0001”, the details of the abnormal situation “the robot apparatus 7 has stopped”, which is also an explanation of the error code, and the abnormality cause “failure of the robot apparatus 7”. The user can immediately grasp the details of the abnormality by viewing the cause confirmation screen 341.

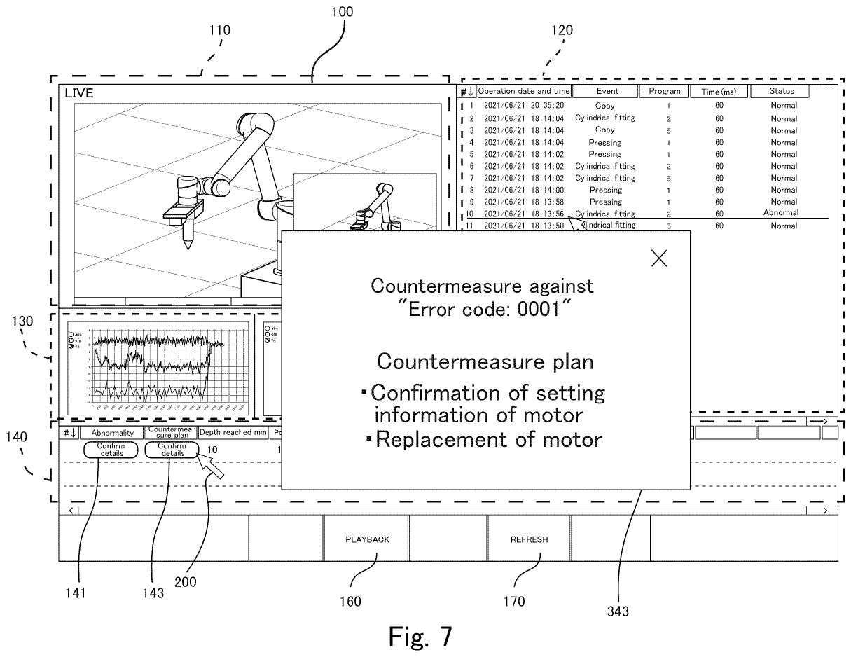

As shown in FIG. 7, when the user clicks the countermeasure plan confirmation button 143 by operating the cursor 200, a countermeasure plan confirmation screen 343 including the text relating to the countermeasure plan for solving the abnormality cause pops up. Note that the countermeasure plan confirmation screen 343 may be displayed in an enlarged manner in the execution history screen 100. For example, as shown in FIG. 7, the countermeasure plan confirmation screen 343 displays countermeasure plans “confirmation of the setting information of the motor” and “replacement of the motor” for the error code “0001” corresponding to the details of the abnormality. These are displayed according to a preset priority order. In other words, the user may confirm the countermeasure plan confirmation screen 343 shown in FIG. 7 and implement the countermeasure plans in the order of “confirmation of the setting information of the motor” and “replacement of the motor”, and can grasp which countermeasure plan should be considered and implemented first.

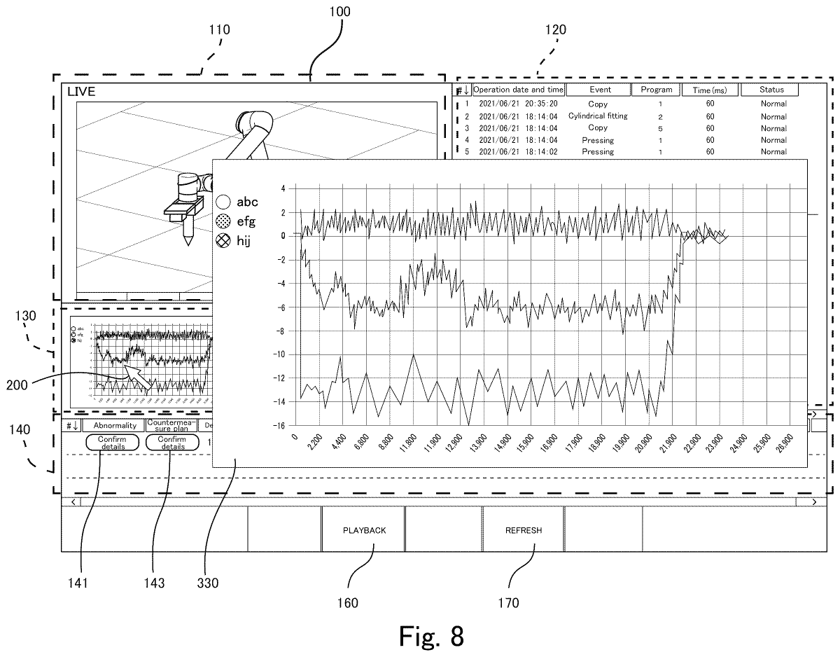

As shown in FIG. 8, when the user selects a graph displayed in the parameter display area 130 by operating the cursor 200, an enlarged screen 330 of the selected graph pops up on the execution history screen 100. The enlarged screen 330 may be displayed in an enlarged manner within the execution history screen 100. The user can confirm the enlarged screen 330 to examine the graph displayed in the parameter display area 130 in detail.

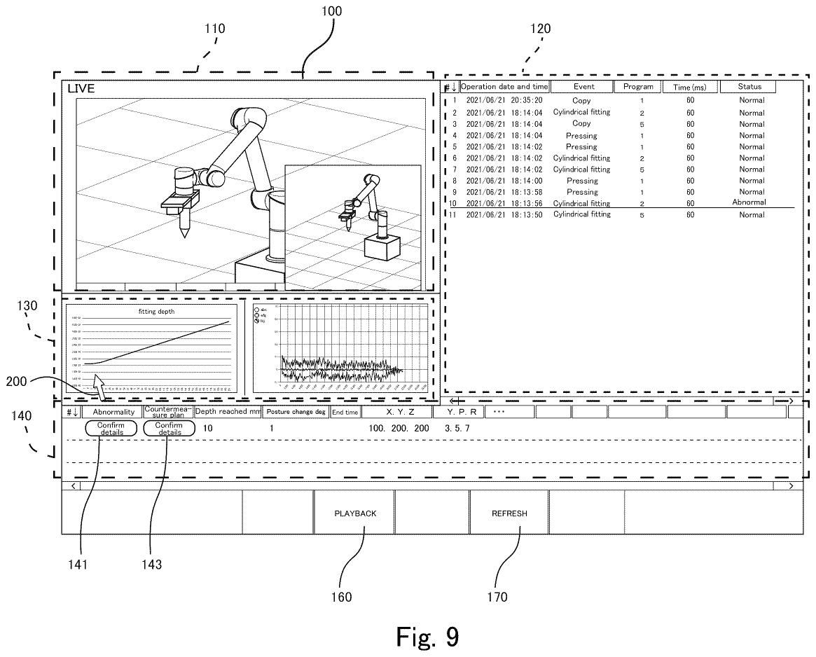

As shown in FIG. 9, the types of parameters displayed in the parameter display area 130 can be changed according to a user instruction. The user may be aware of parameters that may be factors in the occurrence of an abnormal situation when the operation program 62 is tried out on the robot apparatus 7. In such a case, by setting the parameters to be displayed on the execution history screen 100 in advance, when an abnormal situation occurs, it is possible to immediately grasp the parameters having a high possibility of causing the abnormal situation.

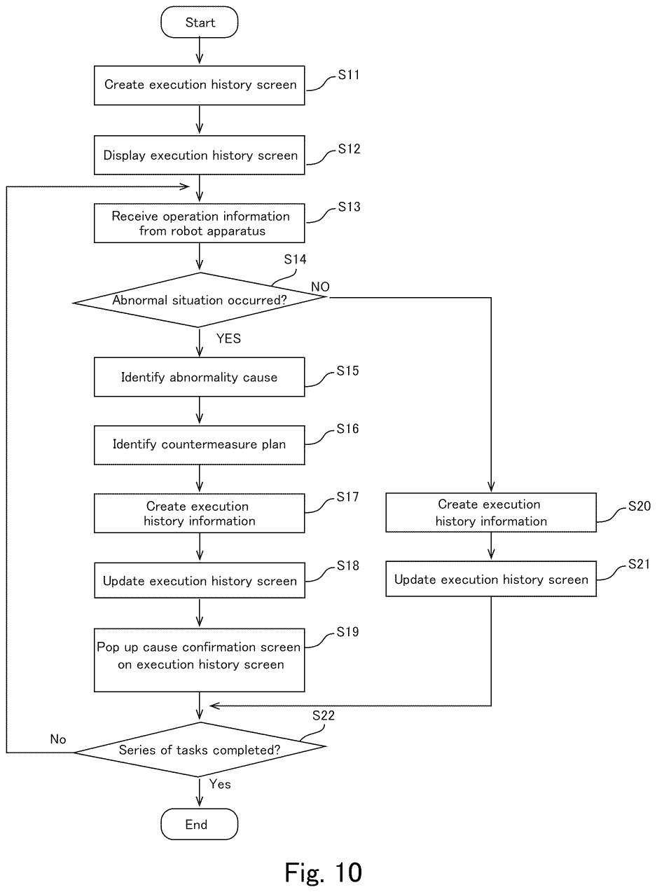

The monitoring processing by the information processing apparatus 1 according to the present embodiment will be described below with reference to FIG. 10.

The monitoring processing by the information processing apparatus 1 is executed when the robot apparatus 7 starts a predetermined task based on the operation program 62. First, the information processing apparatus 1 creates an execution history screen 100 (S11) and displays it on the display unit 4 (S12). The information processing apparatus 1 receives, from the robot apparatus 7, operation information generated by the robot apparatus 7 upon completion of the predetermined task (S13), and identifies whether or not an abnormal situation has occurred, based on sensor data included in the operation information (S14).

When the information processing apparatus 1 detects that an abnormal situation has occurred in the task (S14; YES), the information processing apparatus 1 refers to the cause identification table to identify the abnormality cause (S15). Next, a countermeasure plan for solving the abnormality cause is obtained with reference to the countermeasure plan identification table (S16). Then, the information processing apparatus 1 creates an execution history record corresponding to the task based on the operation information received from the robot apparatus 7, the abnormality cause, and the countermeasure plan (S17), and updates the execution history screen 100 (S18). By the process of step S18, the execution history record created in step S17 is added to the execution history display area 120 of the execution history screen 100. Further, the information processing apparatus 1 pops up the cause confirmation screen 341 to notify the user of the abnormal situation and the abnormality cause (S19). Note that, in the process of step S19, the information processing apparatus 1 may pop up the countermeasure plan confirmation screen 343 together with the cause confirmation screen 341.

In step S14, when it cannot be identified that an abnormal situation has occurred, that is, if the task is normally completed (S14; NO), the information processing apparatus 1 creates an execution history record corresponding to the task based on the operation information received from the robot apparatus 7 (S20) and updates the execution history screen 100 (S21). By the process of step S18, the execution history record created in step S17 is added to the execution history display area 120 of the execution history screen 100.

Each time the predetermined task is executed by the robot apparatus 7, the processes from step S13 to step S21 are executed (S22; NO). Upon completion of a series of tasks by the robot apparatus 7, the monitoring processing is completed (S22; YES).

According to the information processing apparatus 1 of the present embodiment, the following effects are achieved.

The information processing apparatus 1 according to the present embodiment holds a cause identification table in which abnormality causes are associated with abnormal situations, thereby, when an abnormality situation occurs in the monitored robot apparatus 7, automatically displaying the cause confirmation screen 341 for notifying the user of the abnormality cause of the abnormal situation. By viewing the cause confirmation screen 341 displayed on the display unit 4, the user can grasp that an abnormal situation has occurred and can immediately confirm the abnormality cause of the abnormal situation. When an abnormal situation occurs, the time required to confirm the abnormality cause can be made shorter than before, and the abnormal situation can be solved efficiently.

The information processing apparatus 1 displays a countermeasure plan confirmation screen 343 including a countermeasure plan for solving the abnormality cause, in response to a user operation on the execution history screen 100. The user can confirm the countermeasure plan by simply operating on the execution history screen 100 to display the countermeasure plan confirmation screen 343. This contributes to efficiently resolving abnormal situations.

The information processing apparatus 1 also displays the execution history screen 100, as shown in FIG. 5, which collectively show the simulation screen, the list of execution history records, a graph relating to the parameters designated by the user, and details of an execution history record. When an abnormal situation occurs during the execution of a specific task by the robot apparatus 7, the details of the execution history record of the task are displayed in a detailed information display area 140, and the cause confirmation button 141 for confirming the abnormality cause and the countermeasure plan confirmation button 143 for confirming the countermeasure plan for the abnormality cause are displayed together with the details of the abnormal situation. By pressing the cause confirmation button 141, the user can view the cause confirmation screen 341 (FIG. 6) that has popped up on the execution history screen 100 to confirm the details and cause of the abnormal situation. Similarly, by pressing the countermeasure plan confirmation button 143, the user can view the countermeasure plan confirmation screen 343 (FIG. 7) that has popped up on the execution history screen 100 to confirm the countermeasure plan for the abnormality cause. Further, by operating on the execution history screen 100, the user can view the graph or the enlarged screen 330 (FIG. 8) of the simulation screen that has popped up on the execution history screen 100 to examine the abnormality cause in detail.

As described above, the user can confirm the execution history, confirm the occurrence of an abnormal situation and the abnormality cause, confirm the countermeasure plan and examine the details thereof by simply viewing the execution history screen 100 and operating the execution history screen 100 as necessary so that abnormal situations can be solved efficiently. In particular, since the cause confirmation screen 341, the countermeasure plan confirmation screen 343, and the enlarged screen 330 pop up on the execution history screen 100, it is possible to return to the execution history screen 100 simply by closing each pop-up screen when the confirmation of that screen is completed. Therefore, compared with the case where the user confirms the details while switching the pages, the user can solve abnormal situations with high usability and high efficiency.

As long as the output data of various sensors provided in the robot arm mechanism 8 can be input to the information processing apparatus 1 according to the present embodiment, the system configuration is not limited to the above. For example, the information processing apparatus 1 according to the present embodiment may be connected to the robot arm mechanism 8, and output data of various sensors may be directly input to the information processing apparatus 1 according to the present embodiment. Alternatively, the functions of the information processing apparatus 1 according to the present embodiment may be realized in the control device 9 that controls the robot arm mechanism 8.

One feature of the information processing apparatus 1 according to the present embodiment is that when an abnormal situation occurs, the information processing apparatus 1 can notify the user of the details of the abnormal situation and the abnormality cause. As long as this feature can be realized in the information processing apparatus 1, the other processes need not necessarily be executed in the information processing apparatus 1. For example, in the present embodiment, the information processing apparatus 1 executes the process of identifying the abnormal situation and the process of creating the execution history record. However, the robot apparatus 7 may execute the process of identifying the abnormal situation and the process of creating the execution history record, and the information processing apparatus 1 may receive the result of the execution.

While embodiments of the present disclosure have been described in detail, the present disclosure is not limited to the individual embodiments described above. These embodiments may be subjected to various additions, substitutions, modifications, partial deletions, etc., without departing from the gist of the invention or the idea and spirit of the present invention as derived from the contents described in the claims and their equivalents. For example, in the above-described embodiments, the order of the operations and the order of the processes are shown as examples, and the present invention is not limited thereto. The same applies to the case where numerical values or formulas are used in the description of the above-described embodiments.

1. An information processing apparatus connected to an industrial machine equipped with a sensor or a control device for controlling the industrial machine, the information processing apparatus comprising:
a storage unit configured to store first table data in which a plurality of abnormality causes are associated with abnormal situations related to operation of the industrial machine;
an abnormality monitoring unit configured to monitor an occurrence of an abnormal situation in the industrial machine, based on data output from the sensor;
a cause identification unit configured to identify a cause of the abnormal situation with reference to the first table data; and
a display control unit configured to cause a display unit to display details of the abnormal situation and the identified cause of the abnormal situation.

2. The information processing apparatus according to claim 1, wherein the display control unit causes the display unit to display the details of the abnormal situation and the cause of the identified cause of the abnormal situation, based on the occurrence of the abnormal situation.

3. The information processing apparatus according to claim 1, wherein the display control unit causes the display unit to display an execution history screen including execution history information pieces representing operation history records executed by the industrial machine, and causes a screen for notifying the details of the abnormal situation and the identified cause of the abnormal situation pop up on the execution history screen in response to a user operation on the execution history screen.

4. The information processing apparatus according to claim 3, wherein the display control unit causes execution history information pieces in which an abnormal situation occurred to be displayed in a distinguished manner from other execution history information pieces among the execution history information pieces.

5. The information processing apparatus according to claim 3, wherein
the storage unit stores second table data in which a plurality of countermeasure plans for solving an abnormality cause are associated with each of the plurality of abnormality causes,
the information processing apparatus further comprises a countermeasure plan identification unit configured to refer to the second table data and identify a countermeasure plan for solving the abnormal situation, and
the display control unit causes a screen for notifying a countermeasure plan for solving the abnormality cause to pop up on the execution history screen in response to a user operation on the execution history screen.

6. The information processing apparatus according to claim 3, wherein the display control unit causes a three-dimensional model of the industrial machine and time-series data based on an output of the sensor to be displayed on the execution history screen.

7. The information processing apparatus according to claim 6, wherein the display control unit controls the display of the three-dimensional model and the time-series data in order to reproduce an operation of the industrial machine and an output of the sensor corresponding to execution history information piece selected by a user operation on the execution history screen.

8. The information processing apparatus according to claim 3, wherein the display control unit causes a parameter selected according to a user instruction to be displayed on the execution history screen.

9. The information processing apparatus according to claim 1, wherein
in the first table data, the plurality of the abnormality causes are associated with one abnormal situation of the abnormal situations, and
the cause identification unit identifies an abnormality cause of the one abnormal situation from the plurality of abnormality causes, based on an output of the sensor.
